(19) United States
(12) Patent Application Publication
(10) Pub. No.: US 2026/0216799 A1
(43) Pub. Date: Jul. 30, 2026

(54) Machine tool with a tool, and method for operating the machine tool

(71) Applicant: Hilti Aktiengesellschaft, Schaan (LI)

(72) Inventors: Goran GOLUBOVIC, Buchloe (DE); Michael WIERER, Röthis (AT); Markus RANK, Buchloe (DE)

(21) Appl. No.: 19/148,331

(22) PCT Filed: Jan. 23, 2024
(86) PCT No.: PCT/EP2024/051467

§ 371 Date: Jul. 16, 2025

(30) Foreign Application Priority Data
Feb. 14, 2023 (EP) 23156631.6

(51) Int. Cl. B23B 51/04; B23B 45/02; B28D 1/04

(52) U.S. Cl. CPC B23B 51/0453; B23B 45/02; B23B 2270/54; B28D 1/041

(57) ABSTRACT

A machine tool with a tool, wherein the tool is connectable with the aid of a tool fitting to the machine tool, the machine tool has a motor for generating a torque, and wherein the torque is transferrable to the tool fitting with the aid of a power train of the machine tool. A play is provided in the power train, wherein a setpoint current for the motor of the machine tool can be specified with a regularly alternating sign, wherein a frequency for the change in the sign of the motor setpoint current lies in a range from 7 to 60 Hertz. A method for operating the machine tool, wherein a motor setpoint current is predetermined with a frequency in a range of 7 to 60 Hertz, so that a torque is transmitted in different directions of rotation from the motor to the tool fitting of the machine tool and a jammed tool can be released from a borehole.

The present invention relates to a machine tool with a tool, wherein the tool is connectable with the aid of a tool fitting to the machine tool.

### BACKGROUND OF THE INVENTION

Core drilling devices with which cylindrical drill cores can be cut out of solid substrates, such as concrete, masonry or stone, are known in the prior art. Core drilling devices have as a tool a substantially cylindrical drill bit, which is hollow on the inside to receive the drill core. The user of a core drilling device knows from experience that it can be a challenge to remove the drill core from the drill bit once the drilling has been successfully completed and the drill bit has been cut out of the substrate. In addition, it may be difficult to remove a jammed drill bit from a borehole. The problem is often encountered that the release of the drill core from the drill bit or the removal of the drill bit from the borehole takes longer than the actual core drilling process itself.

### SUMMARY OF THE INVENTION

In the prior art, it is known for example to remove the drill core from the drill bit or to remove the drill bit from a borehole by mechanical means. To do this, for example, the drill bit is separated from the core drilling device and an attempt is made to release the drill core from the drill bit by shaking or hammering and to remove it from the inside of the drill bit. This procedure can sometimes be very tedious and time-consuming. In addition, the drill bit can be damaged by the hammer blows and its service life can be shortened.

To carry out such a process of shaking a drill core out of the drill bit, a mechanical slip clutch is often used in machine tools. Mechanical slip clutches can generate auxiliary forces and torque peaks by means of which the drill core can be shaken out of the drill bit. Alternatively, these auxiliary forces and torque peaks can be used to shake a jammed or stuck drill bit free from a borehole. Once the drill bit has been shaken free, it is possible to either continue drilling or simply pull the drill bit out of the borehole.

However, in the course of technical refinements in the field of machine tools, there is a tendency to no longer provide mechanical solutions for individual applications, but instead to use electronic and/or mechatronic solutions to shake free a drill bit. For example, electronic slip clutch solutions are known in the prior art, as are solutions for regulating the torque in the machine tool. However, these electronic and/or mechatronic solutions are often not able to limit the peak torques in the power train of the machine tool, which often occur for very short periods of time, or to utilize them sensibly. In addition, the integration of a slip clutch into the power train of a machine tool can be complex, so that experts would welcome being able to dispense with this additional component.

For example, DE 10 2018 216 702 A1 describes a method for controlling or regulating a hand-held machine tool, wherein two different torques can be applied to a screwing means of the machine tool. EP 4 082 703 A1 discloses a method for releasing a drill core from a drill bit of a core drilling device.

It is an object of the present invention to overcome the above-described disadvantages of the prior art and to provide a method for operating a core drilling device with which the release of a jammed drill bit from a borehole can be improved. Furthermore, experts would welcome it if the method could be used to simplify the removal of a drill core from a drill bit and dispense with a mechanical slip clutch. Moreover, the machine tool to be provided should be configured to be particularly light and compact, so that the handling of the machine tool is made easier and the amount of time that a user can work with the machine tool can be extended. Furthermore, the removal of a drill core from a drill bit or the removal of a tool of the machine tool from a borehole should be faster than with conventional machine tools as known from the prior art. A further aspect of the invention is that a machine tool, in particular a core drilling device, is provided for carrying out the method.

According to the invention, a machine tool with a tool is provided, wherein the tool can be connected to the machine tool by means of a tool fitting. The machine tool has a motor for generating a torque, wherein the torque can be transmitted to the tool fitting with the aid of a power train of the machine tool and a play is provided in the power train of the machine tool. A setpoint current for the motor of the machine tool can be specified with a regularly alternating sign, wherein a frequency for the change in the sign of the motor setpoint current lies in a range from 7 to 60 Hertz. The play lies in a range of 2 to 10 degrees. By providing the play and specifying the motor setpoint current with different signs, particularly high torques, especially torque peaks, can be transmitted from the motor of the machine tool in the direction of the tool fitting. This generates a shaking movement at the tool fitting, which can be used to release a jammed tool from a borehole. The machine tool advantageously does not require a mechanical slip clutch, so that a particularly compact and lightweight machine tool can be provided that ensures convenient operation and handling. It has been shown that with the machine tool it is possible both to facilitate the release of a jammed tool from a borehole and to simplify and significantly speed up the release of a drill core from a tool designed as a drill bit. This is because the shaking movement, which is caused by the motor setpoint current setting with an alternating sign, can be used to shake a drill bit free from a borehole if the drill bit had previously become jammed in the borehole. On the other hand, the shaking movement can be used to release a drill core cut out of a substrate from the inside of the drill bit after the drilling process has been completed in order to be able to start a new drilling process with an “empty” drill bit. Thus, the invention advantageously serves several purposes and improves various functions of the machine tool.

For the purposes of the invention, the wording “regularly alternating sign” preferably covers situations in which the direction of rotation of the motor changes from one direction of rotation to the other. Such a change in the direction of rotation can be achieved in the context of the present invention by the motor setpoint current changing its sign from “plus” to “minus” or from “minus” to “plus” at regular intervals. However, the wording “regularly alternating sign” preferably also includes situations in which the motor of the machine tool does not completely change its direction of rotation, but in which, for example, a motor setpoint current setting with a positive sign becomes “zero” and thus has no sign, or in which a motor setpoint current setting with a negative sign becomes “zero”. The scope of protection of the invention thus preferably also includes situations in which a motor setpoint current setting other than “zero” returns to “zero” and thus to the neutral value. Preferably, the sign sequences mentioned below fall within the scope of protection of the present invention: (+/−/+/−/+), (+/0/+/0/+), (−/0/−/0/−) or (+/0/−/0/+/0/−).

It is preferred in the sense of the invention that the power train of the machine tool comprises a motor, a transmission and a pinion, wherein the pinion is arranged to drive a larger gearwheel, wherein the larger gearwheel is arranged on an output shaft, wherein the output shaft drives the tool of the machine tool. The tool of the machine tool is preferably driven by transmitting a torque from the motor of the machine tool to the tool, wherein the torque is initially transmitted in particular to the tool fitting of the machine tool. The pinion is preferably a first gearwheel that is set up to drive a second gearwheel, wherein the first gear wheel is slightly smaller than the second gear wheel. The gear wheels belong together in the sense that the first gear wheel drives the second gear wheel. In the context of the invention, the second or larger gear wheel can preferably also be referred to as a “large wheel”.

For the purposes of the invention, it is preferable that the larger gear wheel and the output shaft are referred to as components of the power train, although strictly speaking technically they form the output train of the machine tool (see FIG. 2). For the purposes of the invention, the term “power train” refers to both the power train and the output train of the machine tool as a general term. It is therefore preferable for the purposes of the invention that the power train comprises both the motor of the machine tool, the transmission and the pinion on one side (drive side) and the larger gearwheel and the output shaft on the other side (output side). Consequently, pairs of components from these two subgroups that lie next to each other can be “adjacent components of the power train” in the sense of the invention.

For the purposes of the invention, it is preferred for the play to be provided between adjacent components in the power train of the machine tool. For the purposes of the invention, it may also be preferred, however, that the play is realized within a component of the power train of the machine tool.

It is particularly preferred in the sense of the invention that the larger gear wheel and the output shaft represent the “adjacent components of the power train” in the sense of the invention. For the purposes of the invention, it preferred that there is a torque entrainment between the large wheel and the output shaft For the purposes of the invention, this preferably means that a torque is transmitted from the drive shaft of the machine tool to the output shaft with the aid of the large wheel. It is preferred in the sense of the invention that the torque entrainment between the adjacent components of the power train of the machine tool, preferably the large wheel and output shaft, enables the incorporation of a stiffness jump and/or a play in the power train. The stiffness jump can be made possible, for example, by providing one or more torsion springs.

For the purposes of the invention, the term “stiffness jump” preferably means that two components of the power train have different stiffnesses. As a result, there is a large difference in stiffness between these components of the power train, which is referred to as a “stiffness jump” in the context of the invention. For example, a stiffness of the power train can be in a range of 1,000 to 100,000 Nm/rad, while a stiffness of a motor shaft on the drive side of the power train is in a range of greater than 50 Nm/rad. The abbreviation “Nm” stands for the unit “Newton meter”, which is a unit for torque or mechanical work or energy. The abbreviation “wheel” stands for the unit “radiant” of the angle or radian measure. In terms of the invention, it is preferred that the stiffness of the power train is preferably dominated by a stiffness of the output shaft, wherein the output shaft—as explained above—is preferably considered as a component of the power train in the context of the present invention. For the purposes of the invention, the motor shaft of the machine tool may also be referred to as a rotor shaft or drive shaft. For the purposes of the invention, it is preferable that the rotor shaft is significantly thinner than the output shaft of the machine tool.

For the purposes of the invention, it is preferred that the drive shaft and/or the output shaft in the power train are characterized by a specific stiffness, wherein the stiffness of the shafts is preferably specified in the unit Nm/rad. Preferably, the overall stiffness of the power train is less than the smallest individual stiffness of a component within the power train. This is due to the fact that the overall stiffness of the power train can be determined by an imaginary series connection of torsion springs. For the purposes of the invention, it is preferable that the stiffness jump is caused by the play that is generated when the direction of rotation of the motor changes in combination with a rotary stop. For the purposes of the invention, this preferably means that the stiffness jump can preferably be brought about by the provision of the rotary stop. The rapidly changing direction of rotation of the motor can lead to loading and unloading of the power train components.

The term “play” as a general term for the purpose of the invention refers to two different situations: on the one hand, play in the conventional sense of the word, in which preferably two neighbouring components of the power train can move circumferentially at an angle of a few degrees with respect to each other. A particularly preferred play angle can be approximately 6 degrees in the context of the invention. Such conventional play can be present, for example, between the output shaft and the motor shaft or in the region of the gear wheels of the power train. On the other hand, the general term “play” can denote a stiffness jump or stiffness difference between the stiffnesses of two adjacent components of the power train. Such a jump in stiffness can exist, for example, between the stiffnesses of the output shaft (large diameter, high stiffness) and the motor shaft (smaller diameter, low stiffness), wherein the term “stiffness” for the purposes of the invention preferably denotes a torsional stiffness. The invention thus preferably relates to a machine tool with a power train which, due to its design, can implement a rapid change in direction of the motor current setpoint value without causing damage. To fulfil this goal, it has been shown that a power train with a play is particularly suitable.

For the purposes of the invention, it is preferred if, in the context of the present invention, the play is a rotary play in the power train of the machine tool. It is very particularly preferred for the purposes of the invention that the rotary play occurs at the output shaft of the power train of the machine tool. For the purposes of the invention, this preferably means that the rotor shaft can rotate through a play angle without causing the output shaft to rotate. This play angle preferably corresponds to a product of the play and the transmission ratio of the machine tool. The play angle can be for example between 5 and 10 degrees, for example 6 degrees, 7 degrees, 8 degrees, 9 degrees or any intermediate value. If the rotor shaft strikes the above-mentioned rotary stop during its rotation, the play can advantageously be utilized by reversing the direction of rotation in the opposite direction. It is very particularly preferred for the purposes of the invention that the play is provided between the output shaft and gear wheel of the output shaft.

It is provided in accordance with the invention that the play lies in a range from 2 to 10 degrees. The play can preferably lie in a range from 3 to 9 degrees, particularly preferably in a range from 5 to 7 degrees and most preferably at 6 degrees. A value of 6 degrees has proven to be particularly advantageous in order to enable a particularly uncomplicated release of jammed tools, for example drill bits, with different diameters. For example, the drill bits used in the context of the present invention may have a diameter in a range from 12 to 500 mm. Furthermore, it has been shown that a clearance of approximately 6 degrees also enables the removal of a drill core from a drill bit particularly well. For the purposes of the invention, it is preferred that the machine tool is a core drilling device and the tool is a drill bit, wherein a diameter of the drill bit is in a range from 12 to 500 mm. In a particularly preferred embodiment of the invention, the diameter of the drill bit is in a range from 20 to 250 mm.

In the context of the present invention, a motor setpoint current is specified, wherein the motor setpoint current has a frequency in a range from 7 to 60 Hertz. The frequency preferably describes the frequency at which a sign of the predetermined motor current changes (“sign-change frequency”). The sign of the motor current changes in order to cause the tool fitting to move in different directions of rotation. If the drill bit is jammed, the drill bit cannot move but experiences the transmitted torque. The transmission of a torque with different directions of rotation results in a shaking movement which acts on the drill bit and which—as has been shown—is able to free the drill bit from a jammed position. In particular, the use of a brushless motor in the context of the present invention enables such a rapid change of the current setting, which can cause the torque oscillations described. In particular, the rapid change in relation to the sign of the current setting for the motor of the machine tool can introduce torque peaks into the power train, which lead to the shaking movement for releasing the tool of the machine tool. For the purposes of the invention, it is preferred that the motor of the machine tool is a brushless DC motor.

In the context of the invention, it is preferred that the motor torque very quickly follows the motor current. In the sense of the invention, this preferably means that a direction of rotation of the motor adapts particularly quickly to a changed sign setting for the motor current, i.e., that a direction of rotation of the motor changes particularly quickly in accordance with a changed setting for the sign of the motor current.

In addition to the motor, the transmission and the pinion, the power train can also have a spindle. The spindle preferably comprises the output shaft. For the purposes of the invention, it is preferred that the motor torque multiplied by the transmission ratio n of the transmission of the power train arrives at the spindle of the machine tool. For example, if the motor of the machine tool is capable of generating a peak torque of 5 Nm and the transmission of the machine tool has a transmission ratio n=6, this results in a maximum motor torque of approx. 30 Nm, i.e., the product of maximum torque and transmission ratio. Such a value is usually too low to shake free a jammed tool of the machine tool. The inventors have recognized that by providing additional play in the power train of the machine tool, this maximum motor torque can be considerably increased, so that by providing the additional play in the power train, a motor torque can be generated that is advantageously sufficient to shake free a jammed tool of the machine tool. Such a shaking free can advantageously be used to release or remove a jammed drill bit from a borehole.

In addition, the invention can advantageously provide a method for removing a jammed drill core from the drill bit. Such jamming of the drill core within the drill bit may occur, for example, due to deposits between the drill bit and the drill core, wherein such deposits often occur during a drilling process or drilling operation. The deposits can make it difficult to remove or release the drill core from the drill bit. In the context of the present invention, the regularly changing sign of the motor setpoint current and the resulting rapid change in the direction of rotation of the drill bit is now utilized to assist in dislodging a jammed drill core from a drill bit. In other words, the oscillatory rotary movement of the drill bit can be used to release a jammed drill core from the drill bit. The oscillatory rotary movement of the drill bit can preferably also be referred to as shaking. It has been shown that the oscillatory rotary movements of the drill bit can loosen the deposits of the drilling material that lead to the jamming of the drill core in the drill bit. This creates free spaces within the drill bit that enable or facilitate the release of the drill core from the drill bit of the machine tool.

For releasing the drill core from the drill bit, it has proven to be particularly advantageous if the frequency for changing the sign of the motor setpoint current is approx. 20 Hertz. The oscillation movement can consist of clockwise and counter-clockwise rotation, wherein a distribution of approx. 30% counter-clockwise and 70% clockwise rotation has proven to be particularly suitable for making it much easier to cut the drill core out of the drill hole. Such an oscillating movement, which is composed of different proportions of “clockwise rotation” and “counter-clockwise rotation”, is preferably referred to in the sense of the invention as an “asymmetrically composed movement” of the drill bit in the drill hole. For example, with a split of approx. 30% left-hand rotation and 70% right-hand rotation, a system of core drill and drill bit can be provided in which the position of the drill bit in relation to the side walls of the borehole changes slightly during operation. Tests have shown that in this way the entire wall of the borehole has particularly even contact with the drill bit.

The invention preferably relates to a method for releasing a drill core from a drill bit of a machine tool. In the method, a machine tool is provided, wherein a play is provided in the power train of the machine tool. If, after operation of the machine tool, i.e., after a drill core has been cut out of a substrate with the machine tool, a drill core or a drill core remnant remains in the drill bit which cannot be easily released, the drill bit can be moved back and forth with a rotary movement characterized by a rapid change of direction. The rotary movement with the rapid change of direction can be achieved in particular by specifying a motor setpoint current to the motor of the machine tool, wherein the sign of the motor setpoint current changes with a frequency in a range from 7 to 60 Hertz. In the context of the method for loosening a drill core from a drill bit, it is particularly preferred that the drill bit rotates back and forth at a frequency of 10 to 30 Hz, most preferably at a frequency of approx. 20 Hz. This can be achieved in particular by transmitting the torque from the motor to the drill bit, wherein when the torque is transmitted from the motor to the drill bit, the rapidly changing sign of the motor setpoint current advantageously leads to an oscillatory rotary movement of the drill bit of the machine tool, with which a jammed drill core can be released from the drill bit.

In the context of the present invention, the frequency at which the sign of the motor setpoint current setting changes lies within a range of 7 to 60 Hz. However, it may also be preferred in the sense of the invention that the limits within this range are adjustable. For example, an operating parameter of the machine tool can be determined, wherein a lower and/or an upper limit of the range for the sign-change frequency can be set in dependence on this operating parameter. The operating parameter may, for example, be a housing reaction of the machine tool. It is preferred in the sense of the invention that a lower limit of the frequency range is selected in dependence on a hand-arm natural frequency of a user of the machine tool. For example, the lower limit of the frequency range may correspond to twice the natural hand-arm frequency of the user in order to ensure safe and gentle operation of the machine tool for the user. Preferably, the lower limit of the frequency range is around 7 Hertz, i.e., at a frequency of 7 changes of the sign of the motor setpoint current per second. The unit Hertz preferably stands for the unit “1/s” and is abbreviated to “Hz”. Accordingly, a sign-change frequency of 60 Hz stands for 60 changes in the sign of the motor setpoint current per second.

In the context of the invention it is preferred that the motor setpoint current has a substantially rectangular or sinusoidal shape. Preferably, the motor setpoint current can have an offset. The regular sign change of the motor setpoint current advantageously leads to alternating torque peaks, while the offset can lead to a holding torque which must be applied by the user of the machine tool. For the purposes of the invention, it is preferred that a ratio between a torque of the motor (“motor torque”) and an inertia of the motor is greater than 1,000 Nm/(kg·m²). The holding torque for the user of the machine tool is preferably derived from the time average of the motor torque or the housing reaction torque. This advantageously gives the user the feeling that they still have to hold the machine tool.

For the purposes of the invention it is preferred that the transmission of the machine tool has a single-stage or multiple-stage design. Preferably, the transmission can provide a transmission ratio in a range from n=1 to n=30, wherein the value of n=1 preferably corresponds to a direct drive. The transmission ratio of the transmission of the machine tool is not limited here to integer values, but can also be provided by rational numbers, such as 4.4 or 6.4. For the purposes of the invention, it is very particularly preferred if a transmission ratio of the transmission of the machine tool lies in a range from 1 to 30, preferably in a range from 3 to 10, and particularly preferably in a range from 4 to 7.

For the purposes of the invention, it is preferred that a stiffness of the power train lies in a range from 1,000 to 100,000 Nm/rad. Here, the stiffness of the power train is preferably dominated by a stiffness of the output shaft, wherein the output shaft—as explained above—is preferably considered as a component of the power train in the context of the present invention. It is preferred for the purposes of the invention that the output shaft of the machine tool has a larger diameter than the motor shaft, so that the stiffness of the output shaft is significantly greater than the stiffness of the motor shaft. For the purposes of the invention, it is preferred that the stiffness of the motor shaft is in a range of greater than 50 Nm/rad. Thus, it is preferred that a ratio between the stiffness of the power train of the machine tool and the stiffness of the motor shaft of the machine tool is in a range of 20 to 2,000. In other words, the stiffness of the power train or the output shaft can be greater than the stiffness of the rotor shaft of the machine tool by a factor of 20 to 2,000.

For the purposes of the invention, it is preferable that the aforementioned stiffnesses are torsional stiffnesses of the power train, the output shaft or the motor shaft.

In a second aspect, the invention relates to a method for operating a machine tool. The terms, definitions and technical advantages introduced for the machine tool preferably apply analogously to the operating method for the machine tool. The operating method is characterized by the following method steps:
a) providing the machine tool, wherein a play is provided in the power train of the machine tool, wherein the play is in a range of 2 to 10 degrees,
b) specifying a motor setpoint current with a sign-change frequency in a range from 7 to 60 Hertz,
c) transmitting a torque with a sign that changes at regular intervals in accordance with the specified sign-change frequency from the motor to the tool fitting of the machine tool, so that a jammed tool can be released from a borehole.

The transmission of the torque with a sign that changes at regular intervals in accordance with the predetermined sign-change frequency preferably means, in the sense of the invention, that the motor rotates on the basis of the setting of the motor setpoint current, namely in such a direction of rotation that corresponds to a sign of the motor setpoint current. According to the present invention, the specification of this sign of the motor setpoint current changes regularly, wherein the “regularity” results from the sign-change frequency. The sign-change frequency preferably indicates the time intervals at which the sign of the motor setpoint current changes. The motor of the machine tool follows this changed specification by changing its direction of rotation. If the motor of the machine tool is a brushless DC motor, the motor of the machine tool can follow the changed motor setpoint current setting comparatively quickly, so that the use of a brushless DC motor is preferred in the context of the present invention.

When the motor changes its direction of rotation, this changed movement and the changed direction of the corresponding torque are transmitted to the tool fitting via the power train. If the tool of the machine tool is not jammed in a borehole, the rapidly changing movements of the drill bit can generate a shaking movement with which, for example, a drill core located in the drill bit can be shaken free and released from the drill bit. If the drill bit is jammed in a drill hole, the vibrating movement can be used to shake the drill bit itself free from the drill hole and release it. In other words, the shaking movements can be used to release a jammed tool of the machine tool from a borehole. Thus, the method for operating the machine tool can preferably also be referred to as a method for releasing a jammed tool of the machine tool from a borehole. In addition, the invention can be used to release a drill core from the drill bit, advantageously without damaging the drill bit. Furthermore, no tool is required for the removal process, so that the drill core can be removed from the drill bit advantageously without tools. It is preferred in the sense of the invention that by changing the sign of the motor setpoint current, a movement of the tool of the machine tool can be effected in different directions of rotation, which can advantageously be used for releasing a jammed drill bit from a borehole or for releasing a drill core from the drill bit.

Providing play in the power train can lead to a significant increase in the maximum torque values that can be transmitted from the motor to the tool fitting. It has been shown that a transmission play of 6 degrees, for example, contributes to the fact that torque peaks can be generated when the tool or tool fitting oscillates. Tests have shown that with a play of 6 degrees, the most significant increases in torques can be achieved in a range for the sign-change frequency of 15 to 21 Hertz.

For the purposes of the invention, it is particularly preferred for the play to be provided between adjacent components in the power train of the machine tool. For the purposes of the invention, it may also be preferred, however, that the play is realized within a component of the power train of the machine tool.

### BRIEF DESCRIPTION OF THE DRAWINGS

Further advantages can be found in the following description of the figures. The figures, the description and the claims contain numerous features in combination. A person skilled in the art will expediently also consider the features individually and combine them to form sensible further combinations.

Identical and similar components are denoted by the same reference signs in the figures.

In the drawings:

FIG. 1 shows a view of an exemplary preferred embodiment of the machine tool.

FIG. 2 shows a view of an exemplary preferred embodiment of the power train.

### DETAILED DESCRIPTION

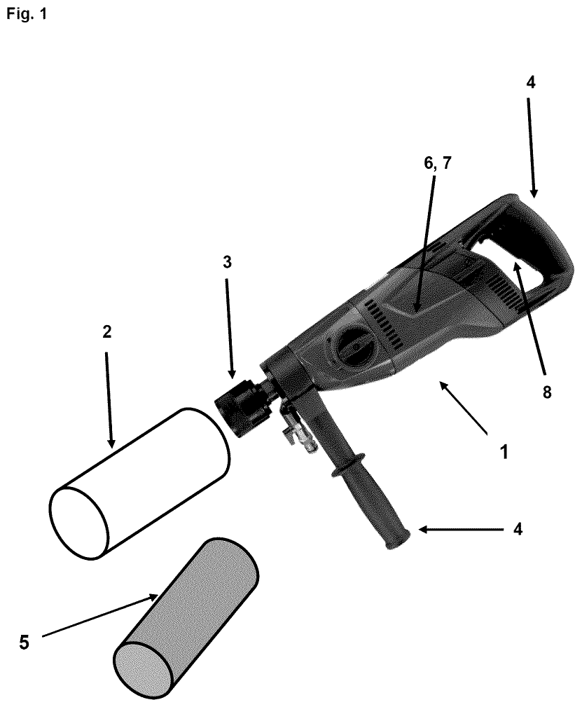

FIG. 1 shows an embodiment of the invention. In particular, FIG. 1 shows a machine tool which is formed as a core drilling device 1 for cutting out drill cores 5 from a hard substrate, such as concrete, stone or masonry. The machine tool 1 can be held by a user by a handle 4 and switched on or off with the aid of a switching device 8. The tool of the core drilling device 1 is a drill bit 2, in which the drill core 5 is received during the cutting process. The machine tool 1 has a motor 6, which receives specifications for the magnitude and direction of the motor current from a control device 7 of the machine tool 1. In the context of the invention, a method for operating a core drilling machine 1 is provided in which the specification of the motor current and in particular its sign changes regularly. The frequency at which this change occurs is preferably referred to as the “sign-change frequency” in the context of the invention. According to the invention, the sign-change frequency lies in a range of 7 to 60 Hz.

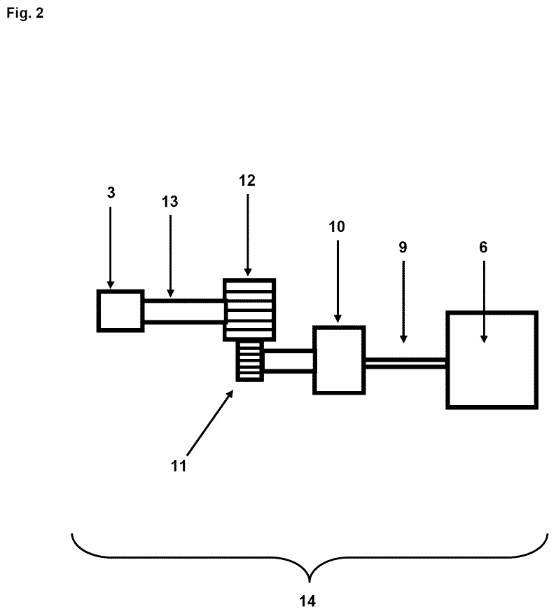

As shown in FIG. 2, machine tool 1 comprises a power train 14, which has the motor 6, a motor shaft 9, a transmission 10 and a pinion 11. The pinion 11 interacts with a larger gear wheel 12, which is arranged on an output shaft 13 of the machine tool 1 (see FIG. 1). For the purposes of the invention, it is preferred that the large wheel 12 and the output shaft 13 are regarded as components of the power train 14 of the machine tool 1. The output shaft 13 is preferably connected to the tool 2, in particular to the tool fitting 3 of the machine tool 1. A play is provided in the power train 14 of the machine tool 1. The term “play” as a general term on the one hand denotes a play in the conventional sense of the word, in which case two adjacent components of the power train 14 can move circumferentially at an angle of a few degrees relative to each other. A particularly preferred play angle can be approximately 6 degrees in the context of the invention. Such a conventional play may be present, for example, between the output shaft 13 and the motor shaft 9 or in the region of the gear wheels 11, 12 of the power train 14. In other words, the play angle of, for example, 6 degrees can be related to the spindle 13, the tool fitting 3 or the drill bit 5.

On the other hand, the general term “play” can denote a stiffness jump or stiffness difference between the stiffnesses of two adjacent components of the power train, for example between the output shaft 13 and the motor shaft 9.

### LIST OF REFERENCE SIGNS

1 Core drilling device
2 Drill bit
3 Tool fitting
4 Handle
5 Drill core
6 Motor of the core drilling device
7 Control device of the core drilling device
8 Switching device
9 Motor shaft
10 Transmission
11 Pinion
12 Large wheel
13 Output shaft
14 Power train

1-15. (canceled)

16: A machine tool comprising:
a tool fitting;
a tool, the tool being connectable with the aid of the tool fitting;
a power train;
a motor for generating a torque, the torque being transferrable to the tool fitting with the aid of the power train;
the power train having a play, a setpoint current for the motor specifiable with a regularly alternating sign, wherein a frequency for the change in sign of the motor setpoint current lies in a range from 7 to 60 Hertz, and wherein the play lies in a range from 2 to 10 degrees.

17: The machine tool as recited in claim 16 wherein the play lies in a range from 3 to 9 degrees.

18: The machine tool as recited in claim 16 wherein the play lies in a range from 5 to 7 degrees.

19: The machine tool as recited in claim 16 wherein the play is at 6 degrees.

20: The machine tool as recited in claim 16 wherein the play is provided between adjacent components of the power train.

21: The machine tool as recited in claim 16 wherein the motor setpoint current has a rectangular or sinusoidal shape.

22: The machine tool as recited in claim 16 wherein the motor setpoint current has an offset.

23: The machine tool as recited in claim 16 wherein an overall stiffness of the power train is less than a smallest individual stiffness of a component of the power train.

24: The machine tool as recited in claim 16 wherein the motor of the machine tool is a brushless DC motor.

25: The machine tool as recited in claim 16 wherein a ratio between a torque of the motor and an inertia of the motor is greater than 1,000 Nm/(kg·m²).

26: The machine tool as recited in claim 16 wherein the power train includes the motor, a transmission and a pinion, the pinion being designed to drive a gearwheel with a larger circumference than the pinion, wherein the gearwheel is arranged on an output shaft designed to drive the tool of the machine tool.

27: The machine tool as recited in claim 26 wherein the transmission has a single-stage design.

28: The machine tool as recited in claim 16 wherein a stiffness of the power train lies in a range from 1,000 to 100,000 Nm/rad.

29: The machine tool as recited in claim 16 wherein the power train includes a motor shaft, wherein a stiffness of the motor shaft lies in a range of greater than 50 Nm/rad.

30: The machine tool as recited in claim 16 wherein the play is a rotary play in the power train on the output shaft.

31: A method for operating the machine tool as recited in claim 16, the method comprising the steps of:
a) providing the machine tool with the play;
b) specifying the motor setpoint current with the sign-change frequency in the range from 7 to 60 Hertz; and
c) transmitting a torque with a sign that changes at regular intervals in accordance with the specified sign-change frequency from the motor to the tool fitting of the machine tool to enable a jammed tool to be released from a borehole.

32: The method as recited in claim 31 wherein a ratio between a stiffness of the power train and a motor shaft lies in a range from 20 to 2,000.
